(19) United States
(12) Patent Application Publication
(10) Pub. No.: US 2022/0250316 A1
(43) Pub. Date: Aug. 11, 2022

(54) MODULAR EXTRUSION SYSTEM FOR FORMING AN ARTICLE

(71) Applicant: General Electric Company, Schenectady, NY (US)

(72) Inventors: James Robert Tobin, Greenville, SC (US); Andrew McCalip, Houston, TX (US)

(21) Appl. No.: 17/629,961

(22) PCT Filed: Jul. 26, 2019
(86) PCT No.: PCT/US2019/043689

§ 371 Date: Jan. 25, 2022

(51) Int. Cl. B29C 64/209; B29C 64/106; B29C 64/393; B29C 64/329; B33Y 30/00; B33Y 50/02

(52) U.S. Cl. CPC B29C 64/209; B29C 64/106; B33Y 50/02; B29C 64/329; B33Y 30/00; B29C 64/393

(57) ABSTRACT

A modular extrusion system for forming an article includes a support frame and a plurality of print head modules removably connected to the support frame. Each of the print head modules includes a printer head, a printer nozzle, a hopper, and an integrated control module. The hoppers are configured for holding a plurality of polymer pellets. The printer heads of the plurality of print head modules each include a body defining a barrel, a rotating extrusion screw extending through the barrel, and one or more heaters at least partially surrounding the barrel for melting the plurality of polymer pellets into a polymer resin formulation. The printer nozzles are configured for printing and depositing the polymer resin formulation onto a substrate to form the article. The modular extrusion system also includes a control system communicatively coupled to each of the integrated control modules for controlling the modular extrusion system.

### FIELD

The present disclosure relates in general to additive manufacturing, and more particularly to modular extrusion systems for forming an article, such as a rotor blade component of a wind turbine.

### BACKGROUND

Wind power is considered one of the cleanest, most environmentally friendly energy sources presently available, and wind turbines have gained increased attention in this regard. A modern wind turbine typically includes a tower, a generator, a gearbox, a nacelle, and one or more rotor blades. The rotor blades capture kinetic energy of wind using known foil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

The rotor blades generally include a suction side shell and a pressure side shell typically formed using molding processes that are bonded together at bond lines along the leading and trailing edges of the blade. Further, the pressure and suction shells are relatively lightweight and have structural properties (e.g., stiffness, buckling resistance and strength) which are not configured to withstand the bending moments and other loads exerted on the rotor blade during operation. Thus, to increase the stiffness, buckling resistance and strength of the rotor blade, the body shell is typically reinforced using one or more exterior structural components (e.g. opposing spar caps with a shear web configured therebetween) that engage the inner pressure and suction side surfaces of the shell halves.

The spar caps are typically constructed of various materials, including but not limited to glass fiber laminate composites and/or carbon fiber laminate composites. The shell of the rotor blade is generally built around the spar caps of the blade by stacking layers of fiber fabrics in a shell mold. The layers are then typically infused together with a resin.

With the increase in popularity of additive manufacturing and extrusion systems, however, it would be desirable to manufacture some of the various wind turbine components using such techniques. Although, certain considerations must be taken into account when manufacturing wind turbine components, such as size, adhesion, loading, stiffness, strength, etc.

Typically, extrusion systems are large floor-mounted machines that weigh thousands of pounds and operate in a horizontal configuration. Even the smallest laboratory grade extruder can occupy a floor space of tens of square feet. Control panels are typically mounted on the unit itself. Typical frames for such units are cast iron or steel with heavy iron core induction motors with low efficiency.

Further, single screw extrusion designs generate the bulk of the heat through high friction shearing of the resin material. As such, very little energy is required of the electrical band heaters placed around the perimeter of the barrel within the extruder. Accordingly, the primary energy source of such systems is the electric motor that is used to turn the screw. Such a design requires a very large gearbox, which adds to the weight and internet of the system. Thus, for such systems to be effective, the length to diameter ratio (commonly referred to as the L/D ratio) must be greater than 24:1.

In addition, automated machinery is typically built with centralized electrical control cabinets with harnesses that convey power and signal to the mounting locations of the motors and its components. This requires custom length harnesses manufactured for each specific mounting location. In addition, such a configuration may require high bandwidth signals/sensitive signals to travel up to a hundred feet between the machinery and the control cabinet, thereby increasing the number and bulk of control cables. As the desired part to be extruded expands in size, it also becomes increasingly difficult to centralize all the control equipment. At a certain size, the cable harness length exceeds the servo amplifiers maximum length rating.

In view of the foregoing, the present disclosure is directed to improved modular extrusion systems for forming an article that addresses the aforementioned issues.

### BRIEF DESCRIPTION

Aspects and advantages of the invention will be set forth in part in the following description, or may be obvious from the description, or may be learned through practice of the invention.

In one aspect, the present disclosure is directed to a modular extrusion system for forming an article. The modular extrusion system includes a support frame and a plurality of print head modules removably connected to the support frame. Each of the print head modules includes a printer head, a printer nozzle, at least one hopper, and an integrated control module. The hoppers are configured for holding a plurality of polymer pellets. The printer heads of the plurality of print head modules each include a body defining a barrel, a rotating extrusion screw extending through the barrel, and one or more heaters at least partially surrounding the barrel for melting the plurality of polymer pellets into a polymer resin formulation. The printer nozzles are configured for printing and depositing the polymer resin formulation onto a substrate to form the article. The modular extrusion system also includes a control system communicatively coupled to each of the integrated control modules for controlling the modular extrusion system.

In an embodiment, each of the integrated control modules of each of the plurality of print head modules may be housed within a housing and may include an actuator contained therein. As such, the actuators are configured for moving each of the plurality of print head modules along at least one axis, such as a z-axis.

In another embodiment, each of the integrated control modules may include a servo motor and a servo gearbox, such as a planetary reduction servo gearbox, for controlling the actuator. In further embodiments, each of the integrated control modules may include a combination of electrical components for driving a respective print head module, the electrical components comprises at least one of one or more amplifiers, one or more relays, one or more power supplies, and/or one or more input/output (I/O) devices. In particular embodiments, at least two of the integrated control modules may have the same combination of electrical components such that the at least two of the integrated control modules are interchangeable.

In an embodiment, a diameter of the extrusion screw varies in a compression zone of the extrusion screw between a first end and a second end of the extrusion screw. Further, the diameter of the extrusion screw increases from a first diameter to a second diameter in the compression zone. The second end of the extrusion screw is adjacent to the printer nozzle. Moreover, a depth in flights of the extrusion screw varies within the compression zone.

More specifically, in an embodiment, the depth in flights at a first end of the compression zone of the extrusion screw is greater than a maximum diameter of one or more of the plurality of polymer pellets. In addition, in an embodiment, the depth of the flights decreases from the first end of the compression zone towards a second end of the compression zone such that the depth in flights at the second end of the compression zone is less than the maximum diameter of the one or more of the plurality of polymer pellets.

In another embodiment, the printer nozzle may define an angled die shape.

In additional embodiments, the control system may be communicatively coupled to each of the integrated control modules via a network. Further, in an embodiment, the integrated control modules may be daisy-chained together. As such, the control system is configured to control each of the integrated control modules individually, in synchronization, or a combination thereof.

In several embodiments, each of the plurality of print head modules may be removably connected to the support frame via one or more fasteners.

In particular embodiments, a linear displacement system may be integral with or mounted to the support frame for moving the plurality of print head modules along at least one or more axes, such as along an x-axis and/or a y-axis. In such embodiments, the linear displacement system may be a rail system or a track.

In another aspect, the present disclosure is directed to an individual print head module for use with a modular extrusion system. The print head module includes a hopper for holding a plurality of polymer pellets and a printer head for melting the plurality of polymer pellets into a polymer resin formulation. The printer head includes a body having a barrel extending therethrough, a rotating extrusion screw extending through the barrel, and one or more heaters at least partially surrounding the barrel. The print head module also includes a printer nozzle arranged at an end of the printer head for printing and depositing the polymer resin formulation onto a substrate to form the article. Moreover, the print head module includes an integrated control module having at least one processor and an individual power source for controlling the individual print head module. As such, the integrated control module may be communicatively coupled to an overall control system of the modular extrusion system via a distributed network. It should be understood that the print head module may further include any of the additional features described herein.

In yet another aspect, the present disclosure is directed to a printer head for forming an article from a plurality of polymer pellets. The printer head includes a body having a barrel extending therethrough and a rotating extrusion screw extending through the barrel. The extrusion screw includes a plurality of flights extending from a first end to a second end. Further, a diameter of the extrusion screw varies in a compression zone of the extrusion screw between a first end and a second end of the extrusion screw. The printer head also includes a printer nozzle arranged at the second end of the extrusion screw. As such, a depth in flights at a first end of the compression zone is greater than a maximum diameter of one or more of the plurality of polymer pellets. In addition, the depth of the flights decreases from the first end of the compression zone towards a second end of the compression zone such that the depth in flights at the second end of the compression zone is less than the maximum diameter of the one or more of the plurality of polymer pellets. It should be understood that the printer head may further include any of the additional features described herein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine according to the present disclosure;

FIG. 2 illustrates a perspective view of one embodiment of a rotor blade of a wind turbine according to the present disclosure;

FIG. 3 illustrates an exploded view of the modular rotor blade of FIG. 2;

FIG. 4 illustrates a cross-sectional view of one embodiment of a leading edge segment of a modular rotor blade according to the present disclosure;

FIG. 5 illustrates a cross-sectional view of one embodiment of a trailing edge segment of a modular rotor blade according to the present disclosure;

FIG. 6 illustrates a cross-sectional view of the modular rotor blade of FIG. 2 according to the present disclosure;

FIG. 7 illustrates a cross-sectional view of the modular rotor blade of FIG. 2 according to the present disclosure;

FIG. 8 illustrates a perspective view of one embodiment of a modular extrusion system for forming an article according to the present disclosure;

FIG. 9 illustrates a perspective view of one embodiment of a print module of a modular extrusion system for forming an article according to the present disclosure;

FIG. 10A illustrates a side view of one embodiment of an integrated control module of a modular extrusion system for forming an article according to the present disclosure;

FIG. 10B illustrates a back view of one embodiment of an integrated control module of a modular extrusion system for forming an article according to the present disclosure;

FIG. 11 illustrates a partial, perspective view of one embodiment of a print module of a modular extrusion system being mounted to a support frame according to the present disclosure;

FIG. 12 illustrates a rear, perspective view of one embodiment of an integrated control module of a modular extrusion system for forming an article according to the present disclosure;

FIG. 13 illustrates a cross-sectional view of one embodiment of a printer head of a print module of a modular extrusion system according to the present disclosure;

FIG. 14 illustrates a partial, cross-sectional view of one embodiment of a printer head of a print module of a modular extrusion system according to the present disclosure;

FIG. 15A illustrates a front, side view of one embodiment of a barrel of a printer head of a print module of a modular extrusion system according to the present disclosure;

FIG. 15B illustrates a cross-sectional view of one embodiment of a barrel of a printer head of a print module of a modular extrusion system according to the present disclosure;

FIG. 15C illustrates a rear, side view of one embodiment of a barrel of a printer head of a print module of a modular extrusion system according to the present disclosure;

FIG. 15D illustrates an end view of the barrel of FIG. 15B viewed from line D-D;

FIG. 16A illustrates a side view of one embodiment of an extrusion screw of a printer head of a print module of a modular extrusion system according to the present disclosure;

FIG. 16B illustrates a cross-sectional view of one embodiment of an extrusion screw of a printer head of a print module of a modular extrusion system according to the present disclosure;

FIG. 16C illustrates an end view of the extrusion screw of FIG. 16B viewed from line C-C;

FIG. 17 illustrates a partial, cross-sectional view of one embodiment of an extrusion screw within a barrel of a printer head according to the present disclosure, particularly illustrating a clearance therebetween;

FIG. 18 illustrates a schematic diagram of one embodiment of a control system of a modular extrusion system according to the present disclosure; and

FIG. 19 illustrates a block diagram of one embodiment of a control system of a modular extrusion system according to the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to a modular extrusion system (or a modular three-dimensional (3D) printer) for forming an article. 3-D printing, as used herein, is generally understood to encompass processes used to synthesize three-dimensional objects in which successive layers of material are formed under computer control to create the objects. As such, objects of almost any size and/or shape can be produced from digital model data. It should further be understood that the methods of the present disclosure are not limited to 3-D printing, but rather, may also encompass more than three degrees of freedom such that the printing techniques are not limited to printing stacked two-dimensional layers, but are also capable of printing curved shapes.

The modular extrusion system includes a support frame and a plurality of print head modules removably connected to the support frame. Each of the print head modules includes a printer head, a printer nozzle, a hopper, and an integrated control module. The hoppers are configured for holding a plurality of polymer pellets. The printer heads each include a body defining a barrel, a rotating extrusion screw extending through the barrel, and one or more heaters at least partially surrounding the barrel for melting the plurality of polymer pellets into a polymer resin formulation. The miniaturized printer heads may also each include an actuator. The printer nozzles are configured for printing and depositing the polymer resin formulation onto a substrate to form the article. Further, the modular extrusion system also includes a control system communicatively coupled to each of the integrated control modules for controlling the modular extrusion system.

Thus, by moving all the electronics, control apparatus, and mechanical structural to a unified package, several advantages were realized. For example, the modular printer heads can be smaller and lighter through the use of a lightweight unified body structure along with several integrated features such as water cooling, shortened barrel design, and compact high power density drive motors. More specifically, the modular printer heads may utilize servo motors and planetary gearbox reducers to reduce the mass, e.g. by about 90%. Moreover, the modular extrusion system includes an improved extrusion screw having optimized extrusion screw dimensions (e.g. which allows for shorter and more efficient extruders) as described herein for the average pellet size, which provides a high flowrate extrusion screw. The modular extrusion system may also include an angled back die to allow the printer heads to print on slopes up to 45 degrees from horizontal.

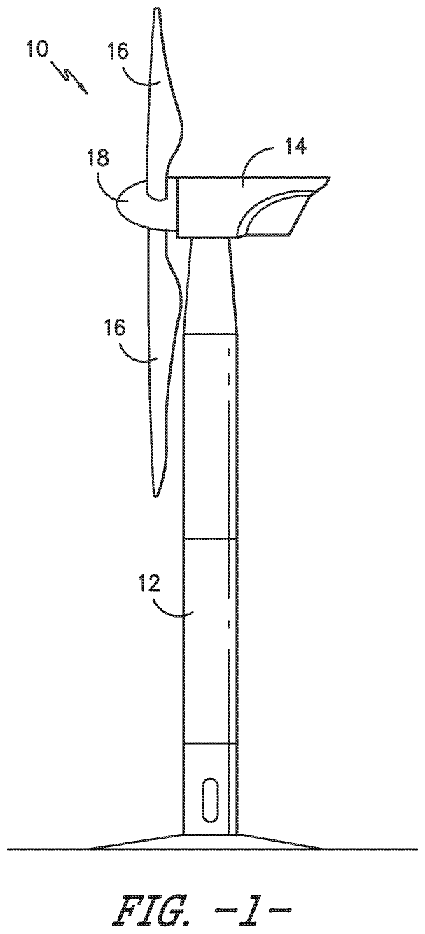

Referring now to the drawings, FIG. 1 illustrates one embodiment of a wind turbine 10 according to the present disclosure. As shown, the wind turbine 10 includes a tower 12 with a nacelle 14 mounted thereon. A plurality of rotor blades 16 are mounted to a rotor hub 18, which is in turn connected to a main flange that turns a main rotor shaft. The wind turbine power generation and control components are housed within the nacelle 14. The view of FIG. 1 is provided for illustrative purposes only to place the present invention in an exemplary field of use. It should be appreciated that the invention is not limited to any particular type of wind turbine configuration.

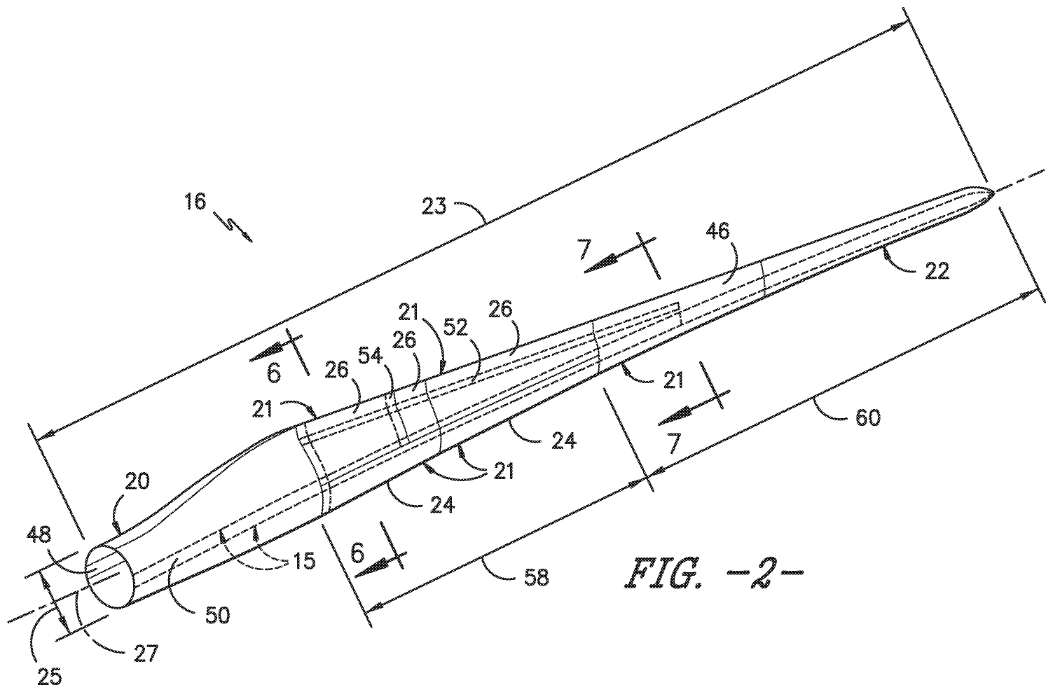

Referring now to FIGS. 2 and 3, various views of a rotor blade 16 according to the present disclosure are illustrated. As shown, the illustrated rotor blade 16 has a segmented or modular configuration. It should also be understood that the rotor blade 16 may include any other suitable configuration now known or later developed in the art. As shown, the modular rotor blade 16 includes a main blade structure 15 and at least one blade segment 21 secured to the main blade structure 15. More specifically, as shown, the rotor blade 16 includes a plurality of blade segments 21.

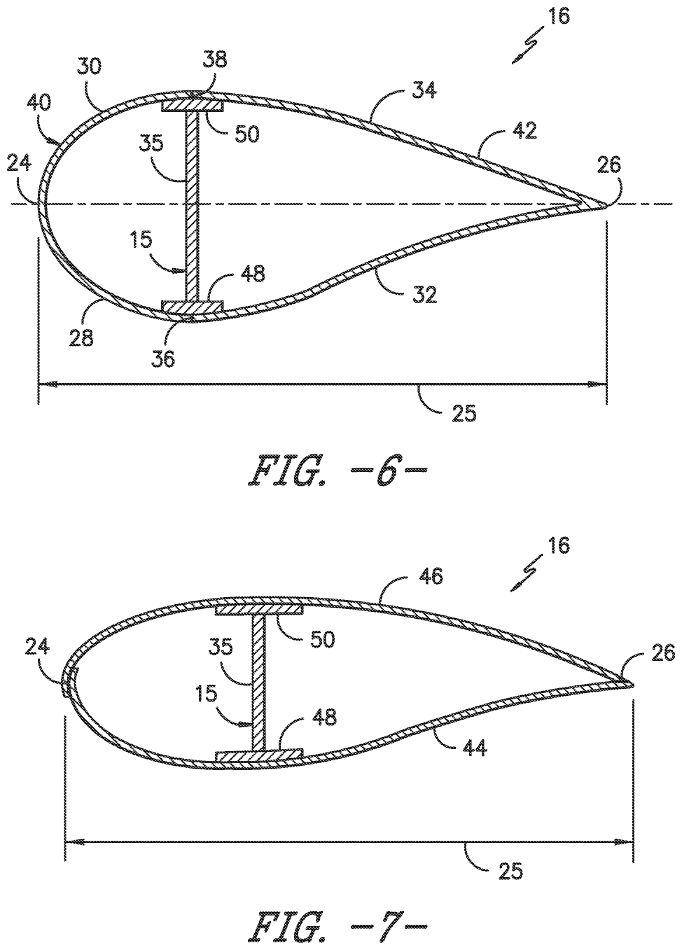

More specifically, as shown, the main blade structure 15 may include any one of or a combination of the following: a pre-formed blade root section 20, a pre-formed blade tip section 22, one or more one or more continuous spar caps 48, 50, 51, 53, one or more shear webs 35 (FIGS. 6-7), an additional structural component 52 secured to the blade root section 20, and/or any other suitable structural component of the rotor blade 16. Further, the blade root section 20 is configured to be mounted or otherwise secured to the rotor 18 (FIG. 1). In addition, as shown in FIG. 2, the rotor blade 16 defines a span 23 that is equal to the total length between the blade root section 20 and the blade tip section 22. As shown in FIGS. 2 and 6, the rotor blade 16 also defines a chord 25 that is equal to the total length between a leading edge 24 of the rotor blade 16 and a trailing edge 26 of the rotor blade 16. As is generally understood, the chord 25 may generally vary in length with respect to the span 23 as the rotor blade 16 extends from the blade root section 20 to the blade tip section 22.

Referring particularly to FIGS. 2-4, any number of blade segments 21 or panels (also referred to herein as blade shells) having any suitable size and/or shape may be generally arranged between the blade root section 20 and the blade tip section 22 along a longitudinal axis 27 in a generally span-wise direction. Thus, the blade segments 21 generally serve as the outer casing/covering of the rotor blade 16 and may define a substantially aerodynamic profile, such as by defining a symmetrical or cambered airfoil-shaped cross-section.

In additional embodiments, it should be understood that the blade segment portion of the blade 16 may include any combination of the segments described herein and are not limited to the embodiment as depicted. More specifically, in certain embodiments, the blade segments 21 may include any one of or combination of the following: pressure and/or suction side segments 44, 46, (FIGS. 2 and 3), leading and/or trailing edge segments 40, 42 (FIGS. 2-6), a non-jointed segment, a single-jointed segment, a multi jointed blade segment, a J-shaped blade segment, or similar.

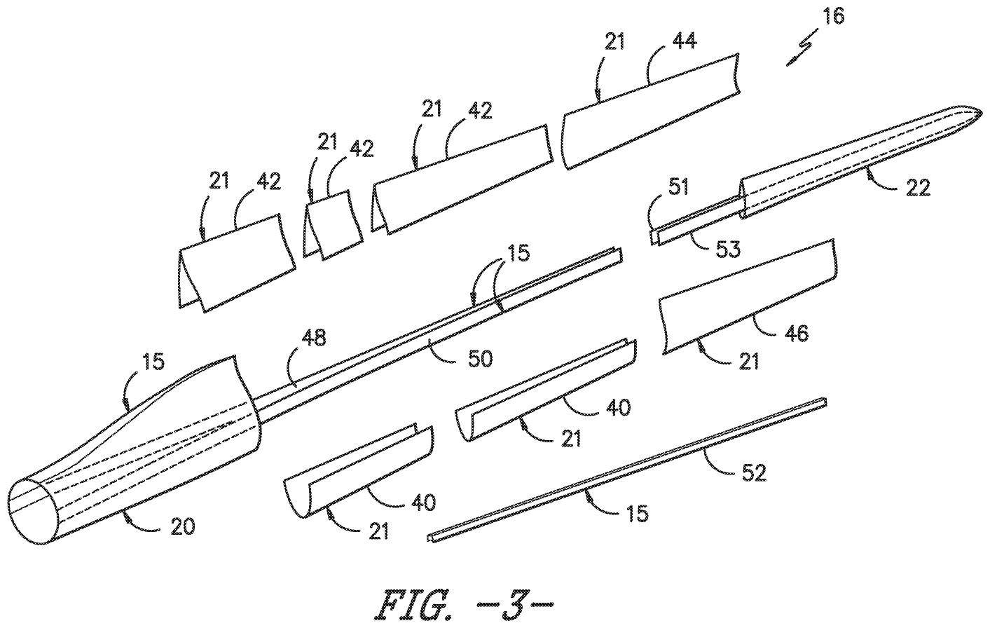

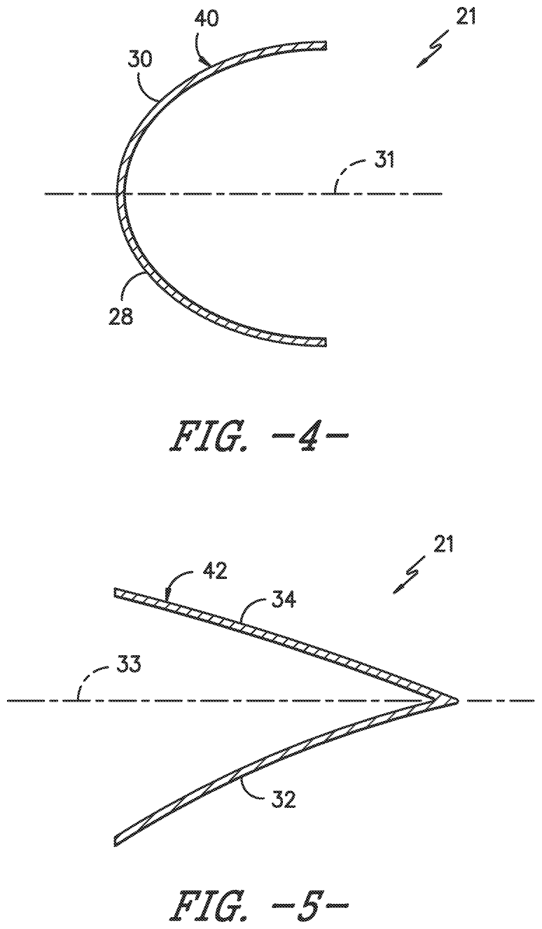

More specifically, as shown in FIG. 4, the leading edge segments 40 may have a forward pressure side surface 28 and a forward suction side surface 30. Similarly, as shown in FIG. 5, each of the trailing edge segments 42 may have an aft pressure side surface 32 and an aft suction side surface 34. Thus, the forward pressure side surface 28 of the leading edge segment 40 and the aft pressure side surface 32 of the trailing edge segment 42 generally define a pressure side surface of the rotor blade 16. Similarly, the forward suction side surface 30 of the leading edge segment 40 and the aft suction side surface 34 of the trailing edge segment 42 generally define a suction side surface of the rotor blade 16. In addition, as particularly shown in FIG. 6, the leading edge segment(s) 40 and the trailing edge segment(s) 42 may be joined at a pressure side seam 36 and a suction side seam 38. For example, the blade segments 40, 42 may be configured to overlap at the pressure side seam 36 and/or the suction side seam 38. Further, as shown in FIG. 2, adjacent blade segments 21 may be configured to overlap at a seam 54. Alternatively, in certain embodiments, the various segments of the rotor blade 16 may be secured together via an adhesive (or mechanical fasteners) configured between the overlapping leading and trailing edge segments 40, 42 and/or the overlapping adjacent leading or trailing edge segments 40, 42.

In specific embodiments, as shown in FIGS. 2-3, the blade root section 20 may include one or more longitudinally extending spar caps 48, 50 infused therewith. For example, the blade root section 20 may be configured according to U.S. application Ser. No. 14/753,155 filed Jun. 29, 2015 entitled “Blade Root Section for a Modular Rotor Blade and Method of Manufacturing Same” which is incorporated herein by reference in its entirety.

Similarly, the blade tip section 22 may include one or more longitudinally extending spar caps 51, 53 infused therewith. More specifically, as shown, the spar caps 48, 50, 51, 53 may be configured to be engaged against opposing inner surfaces of the blade segments 21 of the rotor blade 16. Further, the blade root spar caps 48, 50 may be configured to align with the blade tip spar caps 51, 53. Thus, the spar caps 48, 50, 51, 53 may generally be designed to control the bending stresses and/or other loads acting on the rotor blade 16 in a generally span-wise direction (a direction parallel to the span 23 of the rotor blade 16) during operation of a wind turbine 10. In addition, the spar caps 48, 50, 51, 53 may be designed to withstand the span-wise compression occurring during operation of the wind turbine 10. Further, the spar cap(s) 48, 50, 51, 53 may be configured to extend from the blade root section 20 to the blade tip section 22 or a portion thereof. Thus, in certain embodiments, the blade root section 20 and the blade tip section 22 may be joined together via their respective spar caps 48, 50, 51, 53.

Referring to FIGS. 6-7, one or more shear webs 35 may be configured between the one or more spar caps 48, 50, 51, 53. More particularly, the shear web(s) 35 may be configured to increase the rigidity in the blade root section 20 and/or the blade tip section 22. Further, the shear web(s) 35 may be configured to close out the blade root section 20.

In addition, as shown in FIGS. 2 and 3, the additional structural component 52 may be secured to the blade root section 20 and extend in a generally span-wise direction so as to provide further support to the rotor blade 16. For example, the structural component 52 may be configured according to U.S. application Ser. No. 14/753,150 filed Jun. 29, 2015 entitled “Structural Component for a Modular Rotor Blade” which is incorporated herein by reference in its entirety. More specifically, the structural component 52 may extend any suitable distance between the blade root section 20 and the blade tip section 22. Thus, the structural component 52 is configured to provide additional structural support for the rotor blade 16 as well as an optional mounting structure for the various blade segments 21 as described herein. For example, in certain embodiments, the structural component 52 may be secured to the blade root section 20 and may extend a predetermined span-wise distance such that the leading and/or trailing edge segments 40, 42 can be mounted thereto.

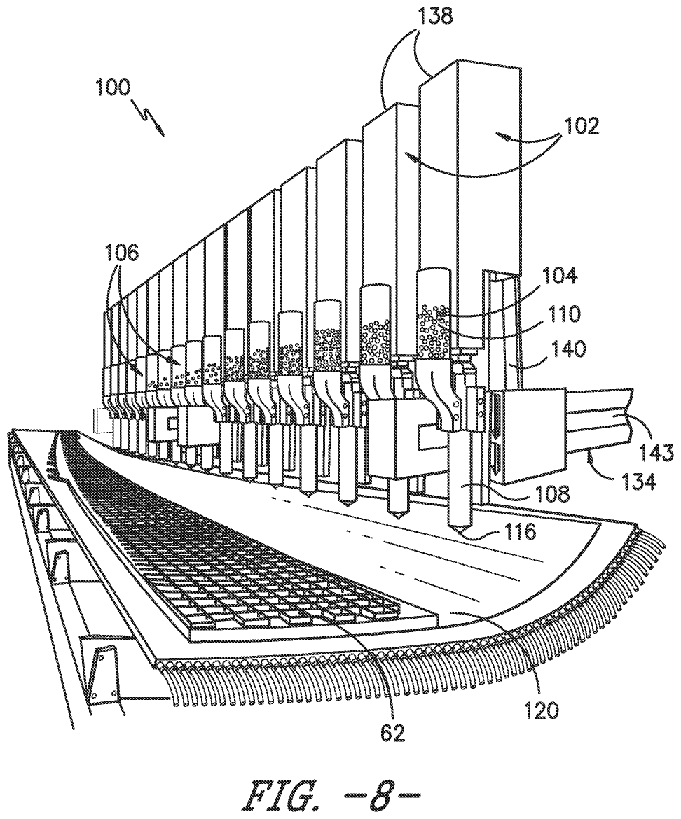

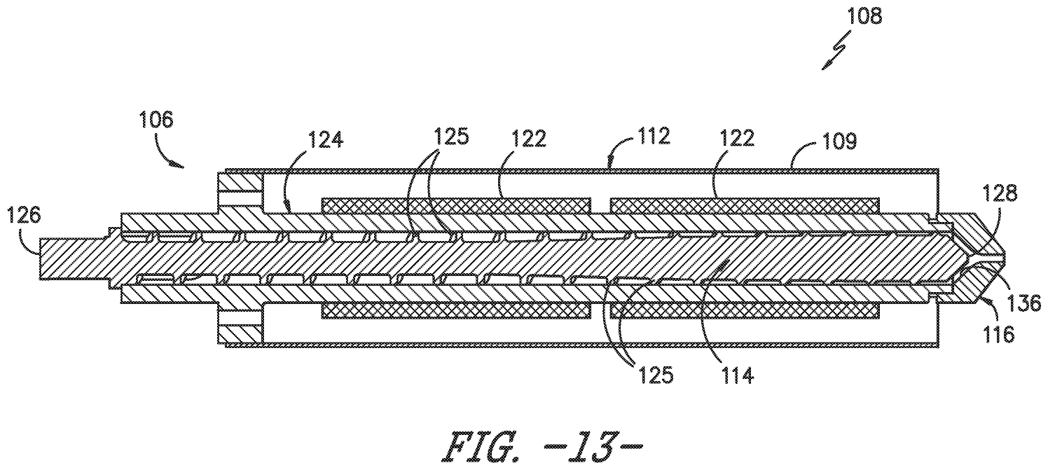

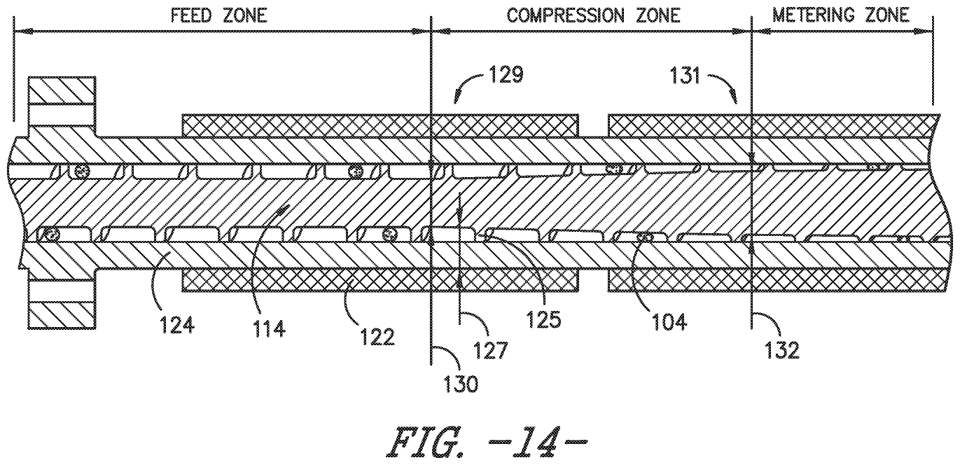

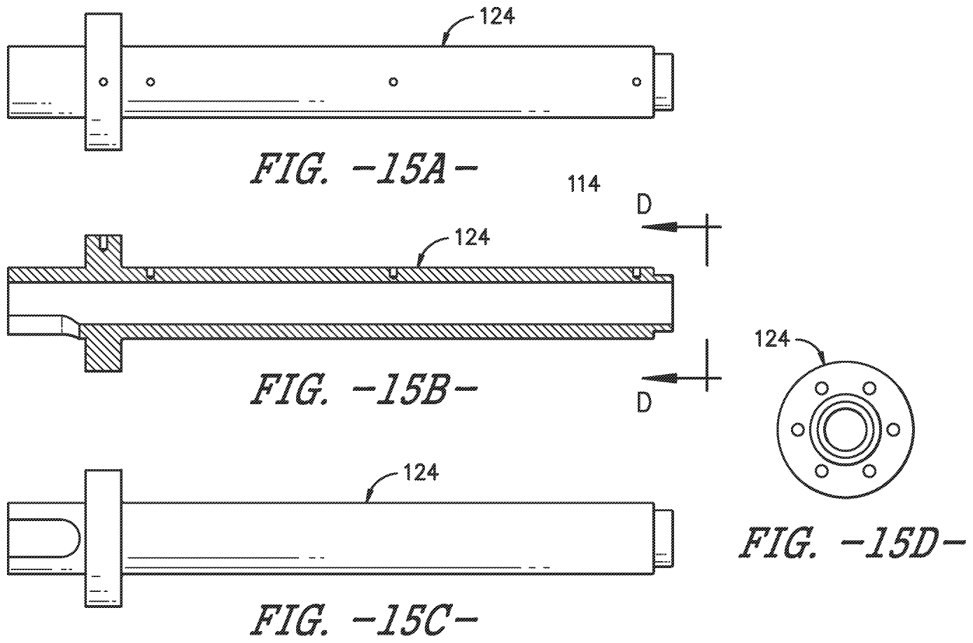

Referring now to FIGS. 8-19, the present disclosure is directed to modular extrusion systems for forming polymer articles, such as any of the rotor blade components described herein, using additive manufacturing with improved drying of the polymer pellets before printing. More specifically, FIG. 8 illustrates a perspective view of one embodiment of a modular extrusion system 100 for forming an article according to the present disclosure. As such, in certain embodiments, the article may include a rotor blade shell (a pressure side shell, a suction side shell, a trailing edge segment, a leading edge segment, a grid structure, etc.), a spar cap, a shear web, a blade tip, a blade root, or any other rotor blade component.

Referring now to FIGS. 8 and 9, in an embodiment, the system 100 may include a plurality of print head modules 106, e.g. aligned in a row. More specifically, as shown particularly in FIG. 8, the plurality of print head modules 106 may be removably connected or otherwise secured to a support frame 134. In particular embodiments, a linear displacement system 143 may be integral with or mounted to the support frame 134 for moving the plurality of print head modules 106 along at least one axis, such as an x-axis and/or a y-axis. In such embodiments, the linear displacement system, for example, may be a rail system, a track, or any suitable movable gantry. In addition, as shown in FIG. 11, each of the plurality of print head modules 106 may be removably connected to the support frame 134 via one or more fasteners 135. More specifically, as shown, each of the print modules 106 may include one or more mounting supports 139 secured thereto that can be secured to the support frame 134 at respective brackets 137 via the fasteners 135.

Referring particularly to FIGS. 8, 9, 10A, and 10B, each of the print head modules 106 includes a printer head 108, a printer nozzle 116, a hopper 110, and an integrated control module 102. Thus, as will be discussed herein and as shown in FIGS. 8 and 9, the hoppers 110 are configured for holding a plurality of polymer pellets 104, the printer heads 108 are configured for melting the polymer pellets 104, and the printer nozzles 116 are configured for printing and depositing the melted polymer pellets 104 onto a substrate 120 to form the article.

More specifically, as shown in FIGS. 8 and 9, the printer heads 108 are configured to melt the dried polymer pellets 104. In addition, the individual printer nozzles 116 are configured to print and deposit the melted polymer pellets 104 to form the article either independently or simultaneously. Accordingly, the print head modules 106 are configured for printing the article onto the substrate 120. For example, as shown in FIG. 8, the substrate 120 may correspond to a two-dimensional or flat surface or a three-dimensional surface, such as a curved rotor blade mold. Further, the substrate 120 may simply be a print surface or may ultimately become part of the final article. Thus, as shown, in an embodiment, the printer nozzles 116 may be configured to print a reinforcement grid structure 62 atop one or more skins on the rotor blade mold, in which case, the substrate 120 corresponds to the skins which become part of the rotor blade 16. Alternatively, the substrate 120 may simply be a support surface for printing the article thereon and then subsequently removed therefrom.

The polymer pellets 104 described herein may include any suitable material, such as for example, thermoplastic materials. Thermoplastic materials described herein generally encompass a plastic material or polymer that is reversible in nature. For example, thermoplastic materials typically become pliable or moldable when heated to a certain temperature and returns to a more rigid state upon cooling. Further, thermoplastic materials may include amorphous thermoplastic materials and/or semi-crystalline thermoplastic materials. For example, some amorphous thermoplastic materials may generally include, but are not limited to, styrenes, vinyls, cellulosics, polyesters, acrylics, polysulphones, and/or imides. More specifically, exemplary amorphous thermoplastic materials may include polystyrene, acrylonitrile butadiene styrene (ABS), polymethyl methacrylate (PMMA), glycolised polyethylene terephthalate (PET-G), polycarbonate, polyvinyl acetate, amorphous polyamide, polyvinyl chlorides (PVC), polyvinylidene chloride, polyurethane, or any other suitable amorphous thermoplastic material. In addition, exemplary semi-crystalline thermoplastic materials may generally include, but are not limited to polyolefins, polyamides, fluropolymer, ethyl-methyl acrylate, polyesters, polycarbonates, and/or acetals. More specifically, exemplary semi-crystalline thermoplastic materials may include polybutylene terephthalate (PBT), polyethylene terephthalate (PET), polypropylene, polyphenyl sulfide, polyethylene, polyamide (nylon), polyetherketone, or any other suitable semi-crystalline thermoplastic material.

Referring particularly to FIGS. 9, 13, and 15A-15D, the printer heads 108 of the plurality of print head modules 106 may each include a body 112 that can act as a heat shield 109 and also defines a non-rotating barrel 124 extending therethrough, a rotating extrusion screw 114 extending through the barrel 124, and one or more heaters 122 at least partially surrounding the barrel 124 for melting the plurality of polymer pellets 104 into a polymer resin formulation. Accordingly, the polymer pellets 104 enter the barrel 124 while the screw 114 is rotating such that a plurality of flights 125 of the screw 114 moves the material through the barrel 124. At the same time, the heaters 122 melt the pellets 104 to form a melted material that can be extruded from the nozzle 116.

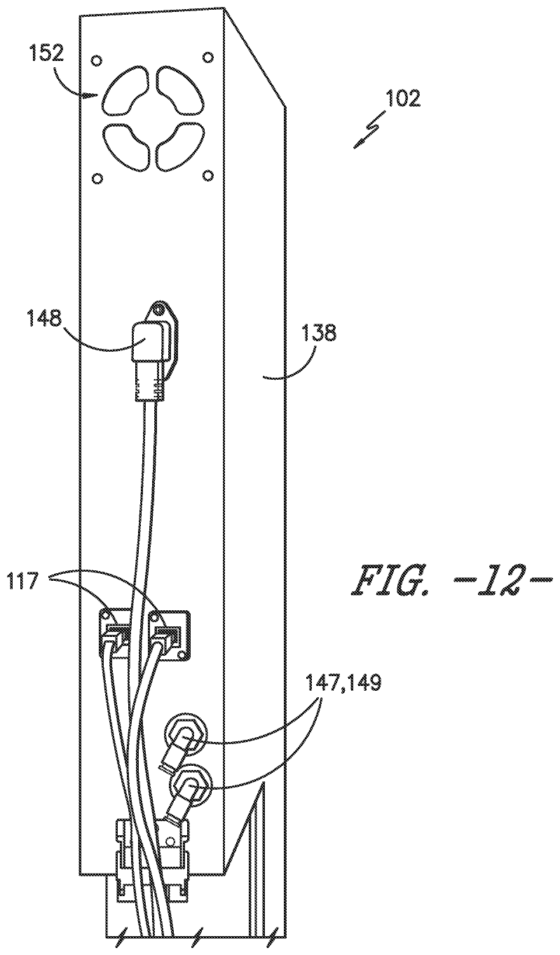

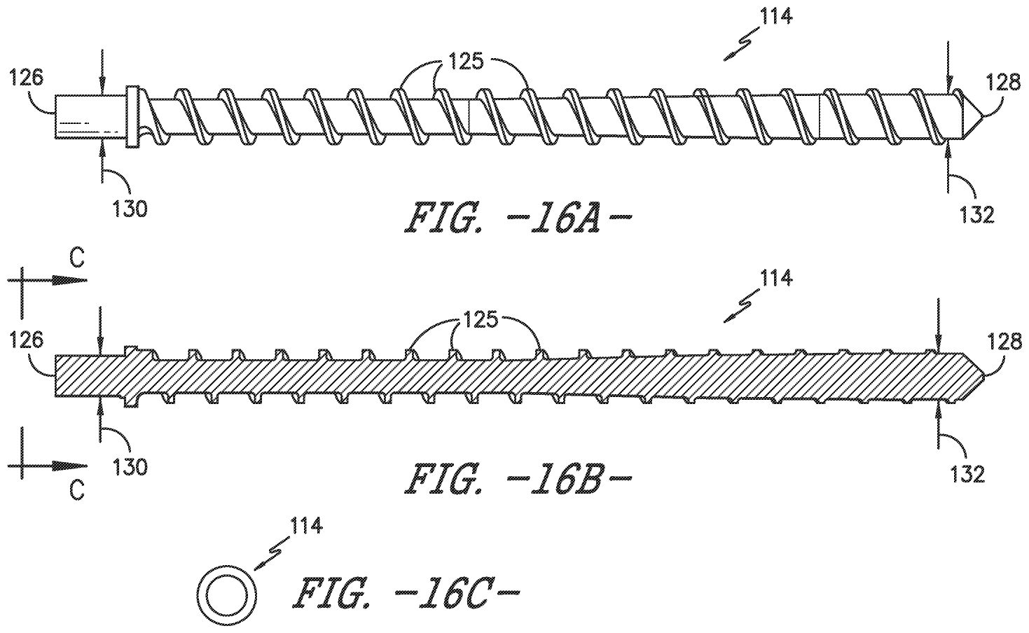

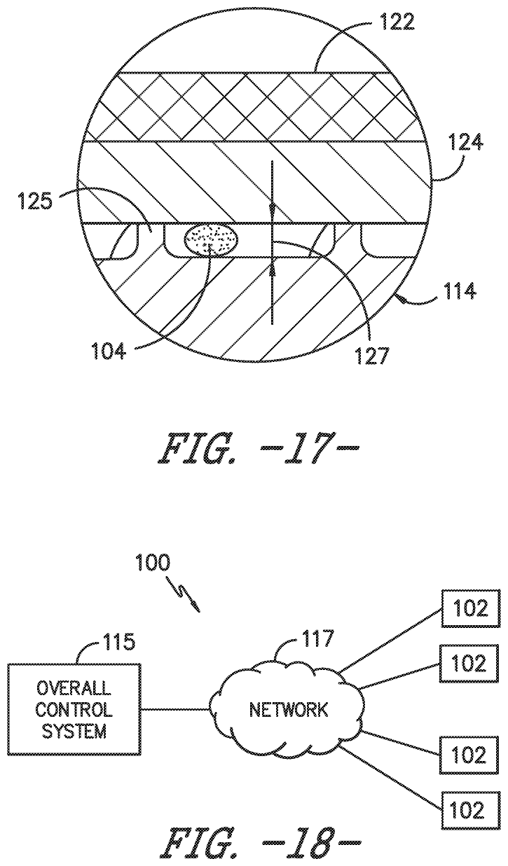

In addition, as shown particularly in FIGS. 13, 16A, 16B, and 16C, the extrusion screw 114 may extend between a first end 126 and a second end 128. Moreover, as shown in FIG. 14, the extrusion screw 114 may include one or more zones, such as for example a feed zone, a transition/compression zone, and a metering zone. Further, as shown in FIG. 14, the extrusion screw 114 may define a diameter 130, 132 that varies in the compression zone. More specifically, as shown in the illustrated embodiment, the diameter of the extrusion screw 114 may increase from a first diameter 130 near the first end 126 of the extrusion screw 114 to a second diameter 132 near the second end 128. Moreover, as shown in FIGS. 13 and 14, the larger, second diameter 132 may be closer to the printer nozzle 116.

Thus, as shown in FIGS. 14 and 17, a depth 127 of the flights 125 of the extrusion screw 114 varies in the compression zone. More specifically, as shown in FIG. 14, the depth 127 in flights 125 at a first end 129 of the compression zone is greater than a maximum diameter of one or more of the plurality of polymer pellets 104. In addition, as shown, the depth 127 in flights 125 decrease from the first end 129 of the compression zone towards a second end 131 of the compression zone such that the depth 127 in flights 125 at the second end 131 of the compression zone is less than the maximum diameter of the one or more of the plurality of polymer pellets 104.

In addition, in an embodiment, the length of the feed zone can be designed such that the polymer pellets 104 do not enter the compression zone before they reach a softening temperature, which reduces the torque requirement of the extrusion screw 114 as the pellets 104 are plastically deformed while it is entering the zone of simultaneous contact with the extrusion screw 114 and inner barrel wall.

Typically one of the polymer pellets 104 measures about 2.9 mm in diameter. By creating the decreased depth 127 of the flights 125 near the second end 128 of the screw 114, a single pellet 104 can be trapped between the moving screw 114 and the barrel 124 (see FIG. 17), which causes the pellet 104 to tumble, thereby increasing the efficiency at which a melt film is created. Traditional screws typically employ a much larger gap (e.g. of about 5 mm to 10 mm) in this region and cannot take advantage of such an effect.

Referring back to FIG. 13, in another embodiment, the printer nozzle 116 may also define an angled die shape 136. Thus, the angled die shape 136 allows the printer nozzles 116 to print on slopes up to about 45 degrees from horizontal. Such a cross-section ensures that a sufficient conduction path exists to transmit heat effectively to the tip of the nozzle 116 to prevent premature solidification of the melt. The flow path is also configured to minimize fiber breakage as the melt transitions from the end of the extrusion screw 114 and flows through the converging exit cone of the nozzle die 136.

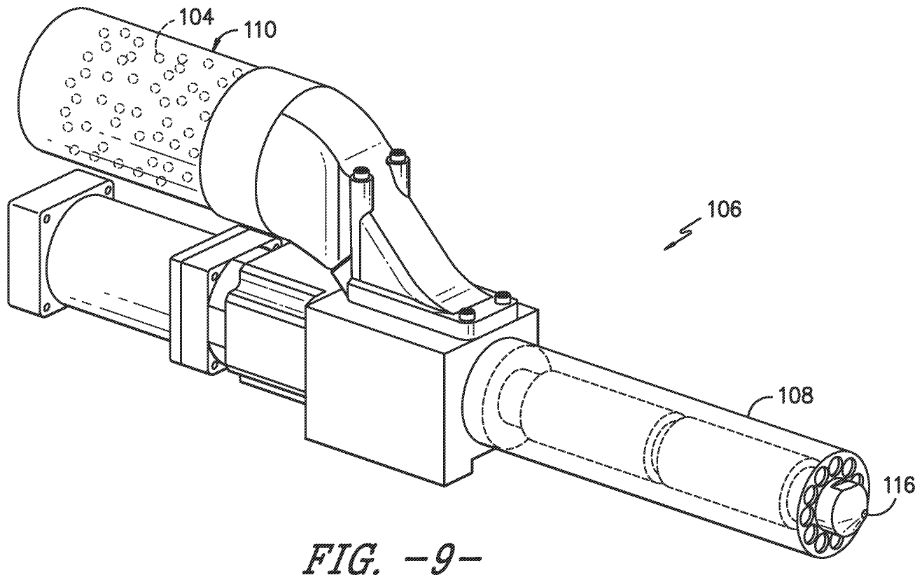

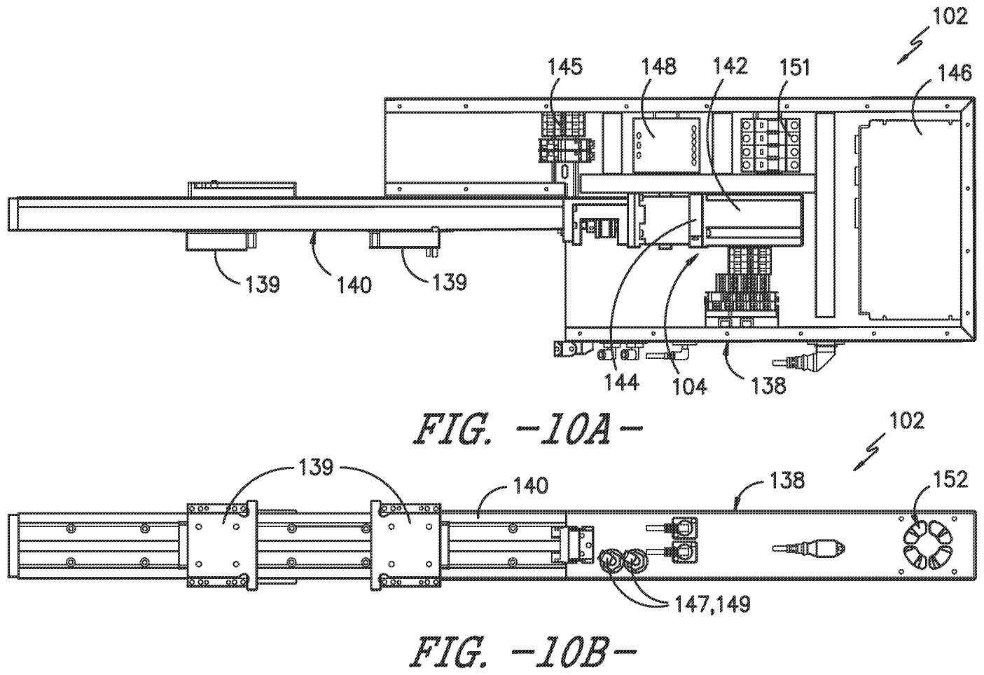

Referring particularly to FIGS. 8, 10A, 10B, 11, and 12, each of the integrated control modules 102 may be housed within a housing 138 or cabinet and may include an actuator 140 contained therein. Thus, as shown particularly in FIGS. 10A and 10B, the actuators 140 are configured for moving each of the print head modules 106 along at least one axis, such as the z-axis. In addition, as shown in FIG. 10A, each of the integrated control modules 102 may include one or more servo motors 142 coupled with a planetary reduction servo gearbox 144 for controlling its respective actuator 140.

In further embodiments, each of the integrated control modules 102 may include a combination of electrical components for driving a respective print head module 106. For example, as shown in FIGS. 10A and 10B, the electrical components may include one or more amplifiers 146, one or more circuit breakers 151, one or more relays 145, one or more power supplies 148, and/or one or more input/output (I/O) devices 150 (e.g. such as Ethercat connections). As such, the servo motor amplifier, relays, power supplies, digital I/O devices, etc. can be located physically adjacent to the components they control. This is possible due to the integrated control box/vertical actuator, which can also reduce cable length of the system 100 (e.g. from about 30 meters to about a half a meter). Accordingly, noise and interference, as well as cost of wiring, is also reduced as compared to prior art systems.

In addition, as shown, in certain embodiments, only a single high voltage source is required for the entire module. In such embodiments, all subsequent power can be converted and filtered inside each of the modules 106. In further embodiments, at least two of the integrated control modules 102 (or all of the integrated control modules 102) may include the same combination of electrical components such that the at least two of the integrated control modules 102 are interchangeable with each other. This permits more efficient manufacturing of the modules 106 as well as ease of maintenance. In addition, this allows for each module 106 to be easily replaced with another module (e.g. in under about five (5) minutes) if maintenance is required. Alternatively, in an embodiment, each of the integrated control modules 102 may include a different combination of electrical components.

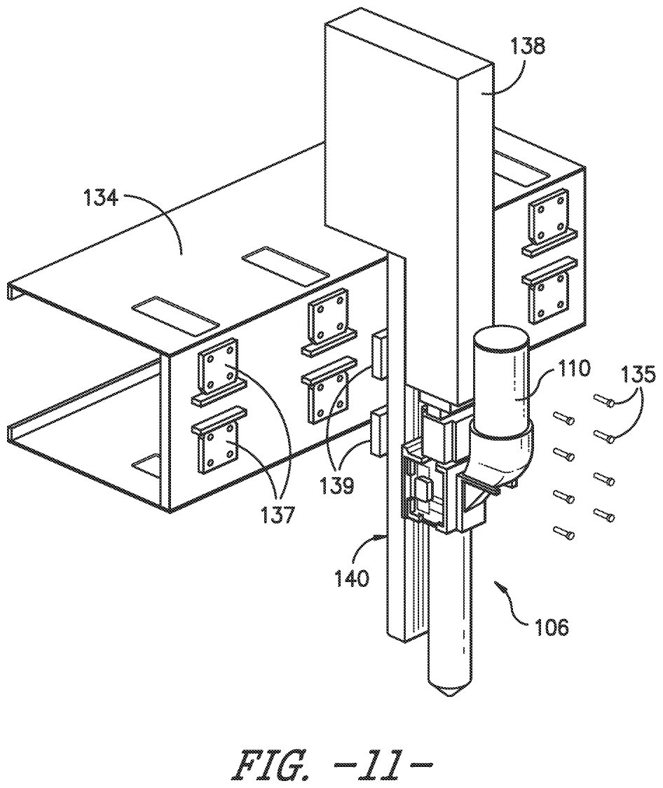

In addition, as shown in FIGS. 10B and 12, the housing 138 may include one or more water cooling inlets and outlets 147, 149 as well as a fan 152 for maintaining a desired temperature within the housing/cabinet 138.

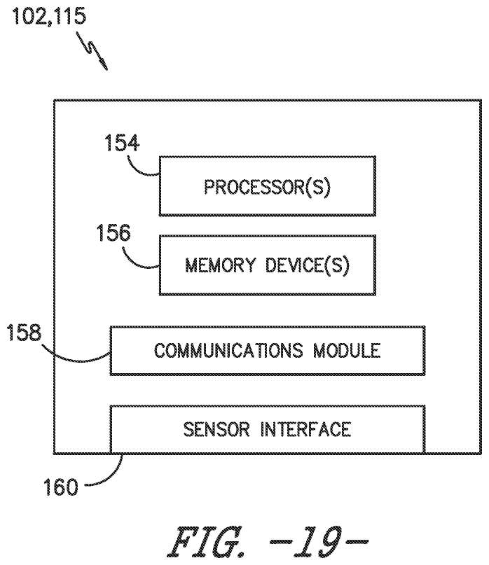

Referring now to FIG. 18, the modular extrusion system 100 may also include an overall control system 115 communicatively coupled to each of the integrated control modules 102 for controlling the modular extrusion system 100. For example, as shown, the control system may be communicatively coupled to each of the integrated control modules 102 via a network 117. Further, in an embodiment, the integrated control modules 102 may be daisy-chained together such that the modular extrusion system 100 has a single high-voltage source. As such, the control system 115 can control each of the integrated control modules 102 individually, in synchronization, or a combination thereof. In particular embodiments, each module 106 may have its own address on the expandable Ethercat control network 117, thereby allowing each module 106 to function as its own independent system, or to be synchronized with any other axis on the system 100. This allows the independent control of the height of each axis. Such control can be critical to the requirement of printing on a turbine blade mold, as each axis is required to track a different region of heights on the mold.

Referring now to FIG. 19, there is illustrated a block diagram of one embodiment of various components of the control system 115 (and/or the individual control modules 102) according to the present disclosure. As shown, the control system 115 may include one or more processor(s) 154 and associated memory device(s) 156 configured to perform a variety of computer-implemented functions (e.g., performing the methods, steps, calculations and the like and storing relevant data as disclosed herein). Additionally, the control system 115 may also include a communications module 158 to facilitate communications between the control system 115 and the various components described herein. Further, the communications module 158 may include a sensor interface 160 (e.g., one or more analog-to-digital converters) to permit signals transmitted from the print modules 106 converted into signals that can be understood and processed by the processor(s) 154. It should be appreciated that one or more sensors 162 may be further incorporated into the system 100 for providing information relating to the individual modules 106. Such sensors 162, for example, may be communicatively coupled to the communications module 158 using any suitable means. For example, as shown in FIG. 19, the sensor(s) 162 may be coupled to the sensor interface 160 via a wired connection. However, in other embodiments, the sensor(s) 162 may be coupled to the sensor interface 160 via a wireless connection, such as by using any suitable wireless communications protocol known in the art.

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 156 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 162 may generally be configured to store suitable computer-readable instructions that, when implemented by the processor(s) 154, configure the control system 115 to perform the various functions described herein.

Various aspects and embodiments of the present invention are defined by the following numbered clauses:

Clause 1. A modular extrusion system for forming an article, comprising:

a support frame;

a plurality of print head modules removably connected to the support frame, each of the print head modules comprising a printer head, a printer nozzle, at least one hopper, and an integrated control module, the hoppers for holding a plurality of polymer pellets, the printer heads each comprising a body defining a barrel, a rotating extrusion screw extending through the barrel, and one or more heaters at least partially surrounding the barrel for melting the plurality of polymer pellets into a polymer resin formulation, the printer nozzles configured for printing and depositing the polymer resin formulation onto a substrate to form the article; and,

a control system communicatively coupled to each of the integrated control modules for controlling the modular extrusion system.

Clause 2. The modular extrusion system of Clause 1, wherein each of the integrated control modules of each of the plurality of print head modules is housed within a housing and further comprises an actuator contained therein, the actuators configured for moving each of the plurality of print head modules along at least one axis.

Clause 3. The modular extrusion system of Clause 2, wherein each of the integrated control modules further comprises a servo motor and a servo gearbox for controlling the actuator.

Clause 4. The modular extrusion system of Clause 2, wherein each of the integrated control modules further comprises a combination of electrical components for driving a respective print head module, the electrical components comprises at least one of one or more amplifiers, one or more relays, one or more power supplies, and/or one or more input/output (I/O) devices.

Clause 5. The modular extrusion system of Clause 2, wherein at least two of the integrated control modules further comprises the same combination of electrical components such that the at least two of the integrated control modules are interchangeable.

Clause 6. The modular extrusion system of any of the preceding clauses, wherein a diameter of the extrusion screw varies in a compression zone of the extrusion screw between a first end and a second end of the extrusion screw, the diameter of the extrusion screw increasing from a first diameter to a second diameter in the compression zone, the second end of the extrusion screw being adjacent to the printer nozzle, wherein a depth in flights of the extrusion screw varies within the compression zone.

Clause 7. The modular extrusion system of Clause 6, wherein the depth in flights at a first end of the compression zone of the extrusion screw is greater than a maximum diameter of one or more of the plurality of polymer pellets.

Clause 8. The modular extrusion system of Clause 7, wherein the depth of the flights decreases from the first end of the compression zone towards a second end of the compression zone such that the depth in flights at the second end of the compression zone is less than the maximum diameter of the one or more of the plurality of polymer pellets.

Clause 9. The modular extrusion system of any of the preceding clauses, wherein the printer nozzle defines an angled die shape.

Clause 10. The modular extrusion system of any of the preceding clauses, wherein the control system is communicatively coupled to each of the integrated control modules via a network, the integrated control modules being daisy-chained together, the control system configured to control each of the integrated control modules individually, in synchronization, or a combination thereof.

Clause 11. The modular extrusion system of any of the preceding clauses, wherein each of the plurality of print head modules is removably connected to the support frame via one or more fasteners.

Clause 12. The modular extrusion system of any of the preceding clauses, further comprising a linear displacement system integral with or mounted to the support frame for moving the plurality of print head modules along at least one axis, the linear displacement system comprising at least one of a rail system or a track.

Clause 13. An individual print head module for use with a modular extrusion system, comprising:

a hopper for holding a plurality of polymer pellets;

a printer head for melting the plurality of polymer pellets into a polymer resin formulation, the printer head comprising a body having a barrel extending therethrough, a rotating extrusion screw extending through the barrel, and one or more heaters at least partially surrounding the barrel;

a printer nozzle arranged at an end of the printer head for printing and depositing the polymer resin formulation onto a substrate to form the article; and,

an integrated control module comprising at least one processor and an individual power source for controlling the individual print head module, the integrated control module being communicatively coupled to an overall control system of the modular extrusion system via a distributed network.

Clause 14. The print head module of Clause 13, wherein the integrated control module is housed within a housing and further comprises an actuator contained therein, the actuator configured for moving the print head module along at least one axis.

Clause 15. The print head module of Clauses 13-14, wherein the integrated control module further comprises a servo motor and a servo gearbox for controlling the actuator.

Clause 16. The print head module of Clauses 13-15, wherein the integrated control module further comprises a combination of electrical components for driving the print head module, the electrical components comprises at least one of one or more amplifiers, one or more relays, one or more power supplies, and/or one or more input/output (I/O) devices.

Clause 17. The print head module of Clauses 13-16, wherein a diameter of the extrusion screw varies in a compression zone of the extrusion screw between a first end and a second end of the extrusion screw, the diameter of the extrusion screw increasing from a first diameter to a second diameter in the compression zone, the second end of the extrusion screw being adjacent to the printer nozzle, wherein a depth in flights of the extrusion screw varies within the compression zone.

Clause 18. The print head module of Clause 17, wherein the depth in flights at a first end of the compression zone of the extrusion screw is greater than a maximum diameter of one or more of the plurality of polymer pellets.

Clause 19. The print head module of Clause 18, wherein the depth of the flights decreases from the first end of the compression zone towards a second end of the compression zone such that the depth in flights at the second end of the compression zone is less than the maximum diameter of the one or more of the plurality of polymer pellets.

Clause 20. A printer head for forming an article from a plurality of polymer pellets, comprising:

a body comprising a barrel extending therethrough;

a rotating extrusion screw extending through the barrel, the extrusion screw comprising a plurality of flights extending from a first end to a second end, wherein a diameter of the extrusion screw varies in a compression zone of the extrusion screw between a first end and a second end of the extrusion screw; and,

a printer nozzle arranged at the second end of the extrusion screw,

wherein a depth in flights at a first end of the compression zone is greater than a maximum diameter of one or more of the plurality of polymer pellets, and

wherein the depth of the flights decreases from the first end of the compression zone towards a second end of the compression zone such that the depth in flights at the second end of the compression zone is less than the maximum diameter of the one or more of the plurality of polymer pellets.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A modular extrusion system for forming an article, comprising:
a support frame;
a plurality of print head modules removably connected to the support frame, each of the print head modules comprising a printer head, a printer nozzle, at least one hopper, and an integrated control module, the hoppers for holding a plurality of polymer pellets, the printer heads each comprising a body defining a barrel, a rotating extrusion screw extending through the barrel, and one or more heaters at least partially surrounding the barrel for melting the plurality of polymer pellets into a polymer resin formulation, the printer nozzles configured for printing and depositing the polymer resin formulation onto a substrate to form the article; and,
a control system communicatively coupled to each of the integrated control modules for controlling the modular extrusion system.

2. The modular extrusion system of claim 1, wherein each of the integrated control modules of each of the plurality of print head modules is housed within a housing and further comprises an actuator contained therein, the actuators configured for moving each of the plurality of print head modules along at least one axis.

3. The modular extrusion system of claim 2, wherein each of the integrated control modules further comprises a servo motor and a servo gearbox for controlling the actuator.

4. The modular extrusion system of claim 2, wherein each of the integrated control modules further comprises a combination of electrical components for driving a respective print head module, the electrical components comprises at least one of one or more amplifiers, one or more relays, one or more power supplies, and/or one or more input/output (I/O) devices.

5. The modular extrusion system of claim 2, wherein at least two of the integrated control modules further comprises the same combination of electrical components such that the at least two of the integrated control modules are interchangeable.

6. The modular extrusion system of claim 1, wherein a diameter of the extrusion screw varies in a compression zone of the extrusion screw between a first end and a second end of the extrusion screw, the diameter of the extrusion screw increasing from a first diameter to a second diameter in the compression zone, the second end of the extrusion screw being adjacent to the printer nozzle, wherein a depth in flights of the extrusion screw varies within the compression zone.

7. The modular extrusion system of claim 6, wherein the depth in flights at a first end of the compression zone of the extrusion screw is greater than a maximum diameter of one or more of the plurality of polymer pellets.

8. The modular extrusion system of claim 7, wherein the depth of the flights decreases from the first end of the compression zone towards a second end of the compression zone such that the depth in flights at the second end of the compression zone is less than the maximum diameter of the one or more of the plurality of polymer pellets.

9. The modular extrusion system of claim 1, wherein the printer nozzle defines an angled die shape.

10. The modular extrusion system of claim 1, wherein the control system is communicatively coupled to each of the integrated control modules via a network, the integrated control modules being daisy-chained together, the control system configured to control each of the integrated control modules individually, in synchronization, or a combination thereof.

11. The modular extrusion system of claim 1, wherein each of the plurality of print head modules is removably connected to the support frame via one or more fasteners.

12. The modular extrusion system of claim 1, further comprising a linear displacement system integral with or mounted to the support frame for moving the plurality of print head modules along at least one axis, the linear displacement system comprising at least one of a rail system or a track.

13. An individual print head module for use with a modular extrusion system, comprising:
a hopper for holding a plurality of polymer pellets;
a printer head for melting the plurality of polymer pellets into a polymer resin formulation, the printer head comprising a body having a barrel extending therethrough, a rotating extrusion screw extending through the barrel, and one or more heaters at least partially surrounding the barrel;
a printer nozzle arranged at an end of the printer head for printing and depositing the polymer resin formulation onto a substrate to form the article; and,
an integrated control module comprising at least one processor and an individual power source for controlling the individual print head module, the integrated control module being communicatively coupled to an overall control system of the modular extrusion system via a distributed network.

14. The print head module of claim 13, wherein the integrated control module is housed within a housing and further comprises an actuator contained therein, the actuator configured for moving the print head module along at least one axis.

15. The print head module of claim 13, wherein the integrated control module further comprises a servo motor and a servo gearbox for controlling the actuator.

16. The print head module of claim 13, wherein the integrated control module further comprises a combination of electrical components for driving the print head module, the electrical components comprises at least one of one or more amplifiers, one or more relays, one or more power supplies, and/or one or more input/output (I/O) devices.

17. The print head module of claim 13, wherein a diameter of the extrusion screw varies in a compression zone of the extrusion screw between a first end and a second end of the extrusion screw, the diameter of the extrusion screw increasing from a first diameter to a second diameter in the compression zone, the second end of the extrusion screw being adjacent to the printer nozzle, wherein a depth in flights of the extrusion screw varies within the compression zone.

18. The print head module of claim 17, wherein the depth in flights at a first end of the compression zone of the extrusion screw is greater than a maximum diameter of one or more of the plurality of polymer pellets.

19. The print head module of claim 18, wherein the depth of the flights decreases from the first end of the compression zone towards a second end of the compression zone such that the depth in flights at the second end of the compression zone is less than the maximum diameter of the one or more of the plurality of polymer pellets.

20. A printer head for forming an article from a plurality of polymer pellets, comprising:
a body comprising a barrel extending therethrough;
a rotating extrusion screw extending through the barrel, the extrusion screw comprising a plurality of flights extending from a first end to a second end, wherein a diameter of the extrusion screw varies in a compression zone of the extrusion screw between a first end and a second end of the extrusion screw; and,
a printer nozzle arranged at the second end of the extrusion screw,
wherein a depth in flights at a first end of the compression zone is greater than a maximum diameter of one or more of the plurality of polymer pellets, and
wherein the depth of the flights decreases from the first end of the compression zone towards a second end of the compression zone such that the depth in flights at the second end of the compression zone is less than the maximum diameter of the one or more of the plurality of polymer pellets.
